(19) United States
(12) Patent Application Publication
(10) Pub. No.: US 2002/0152170 A1
(43) Pub. Date: Oct. 17, 2002

(54) Method and apparatus for processing checks at an automatic teller machine for electronic transfer

(75) Inventors: Rabindranath Dutta, Austin, TX (US); Dwip N. Banerjee, Austin, TX (US)

Correspondence Address: Duke W. Yee, Cartsens, Yee & Cahoon, LLP, P.O. Box 802334, Dallas, TX, 75380, US

(73) Assignee: International Business Machines Corporation, Armonk, NY

(21) Appl. No.: 09/833,344

(22) Filed: Apr. 12, 2001

(51) Int. Cl. G06F 17/60

(52) U.S. Cl. 705/45; 705/43; 382/137; 902/26; 382/321

(57) ABSTRACT

A method and apparatus for processing a check in an automatic teller machine in a data processing system. A check is received in the automatic teller machine. The check is scanned within the automatic teller machine to generate an image. Optical character recognition is performed on the image to generate data. A markup language is created, which is a representation of the check using the data.

### CROSS REFERENCE TO RELATED APPLICATIONS

The present invention is related to the following applications: Method and Apparatus for Processing Checks at an Automatic Teller Machine for Electronic Transfer, Ser. No. ______, attorney docket no. AUS920010211US1; Method and Apparatus for Processing a Check within a Financial System, Ser. No. ______, attorney docket no. AUS920010213US1; Method and Apparatus for Incorporating Scanned Checks into Financial Applications, Ser. No. ______, attorney docket no. AUS920010214US1; Method and Apparatus for Bill Payments at an Automatic Teller Machine, Ser. No. ______, attorney docket no. AUS9200102015US1; and Method and Apparatus for Facilitating Transactions at an Automatic Teller Machine, Ser. No. ______, attorney docket no. AUS920010216US1, filed even date hereof, assigned to the same assignee, and incorporated herein by reference.

### BACKGROUND OF THE INVENTION

1. Technical Field

The present invention relates generally to an improved data processing system and in particular to a method and apparatus for processing checks. Still more particularly, the present invention provides a method and apparatus for processing checks in an automatic teller machine.

2. Description of Related Art

Automatic teller machines (ATMs) are widely available devices used for dispensing cash. An ATM user is provided with an ATM card as well as a personal identification number (PIN) or password for use in withdrawing funds. Typically, the ATM user withdraws cash from a checking account, a savings account, or as an advance from a credit card. A user also may use an ATM to transfer money from a savings account to a checking account. In other instances the user may use the ATM to ascertain an account balance for a checking account or savings account.

Other forms of providing banking services have arisen with the widespread use of the Internet. For example, Internet banks are now commonplace and allow customers to access account information, perform fund transfers, and make other inquiries through the Internet. Many customers, however, still prefer face-to-face contact with a bank employee. Although ATMs do not provide face-to-face contact, these devices do allow physical interaction between the customer and the bank. Further, ATMs also are available 24 hours a day and can be found in almost any location.

With the popularity of ATMs, other uses have been added to these devices other than dispensing cash. For example, some ATMs now provide a feature in which stamps may dispensed to the user rather than cash. Another use is an ability to deposit cash or checks through an ATM. A user places cash or a check in an envelope provided at the ATM. Next, the user places the ATM card into the ATM, enters a PIN number, and selects an option to make a deposit. The user then enters the amount being deposited and places the envelope into the ATM. Deposits are then later collected and processed. This process still requires a physical handling of the cash or check.

Some ATMs provide an ability to scan in the check itself and perform rudimentary processing of the check. With this type of feature, a scanner is included within the ATM and the check may be inserted and scanned for processing. Verification of a signature on the check may be performed at the ATM. A verification of the amount also may be identified with this information being forwarded to the bank. The check, however, is still retained for processing.

With respect to checks, it would be advantageous to have an improved method and apparatus for handling checks in which checks may be processed without requiring the physical check itself.

### SUMMARY OF THE INVENTION

The present invention provides a method and apparatus for processing a check in an automatic teller machine in a data processing system. A check is received in the automatic teller machine. The check is scanned within the automatic teller machine to generate an image. Optical character recognition is performed on the image to generate data. A markup language document is created, which is a representation of the check using the data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a diagram illustrating an automatic teller machine (ATM) in accordance with a preferred embodiment of the present invention;

FIG. 4, is a block diagram illustrating an ATM in accordance with a preferred embodiment of the present invention;

FIG. 5 is a diagram illustrating data flow in creating a check image in accordance with a preferred embodiment of the present invention;

FIG. 6 is a diagram of a smart card, which may be used to create an electronic check, in accordance with a preferred embodiment of the present invention;

FIG. 7 is a diagram of a check presented on a display for completion in accordance with a preferred embodiment of the present invention;

FIG. 8 is a diagram illustrating software components in an ATM in accordance with a preferred embodiment of the present invention;

FIG. 9 is an illustration of a message sent from an ATM to a financial institution in accordance with a preferred embodiment of the present invention;

FIG. 10 is a flowchart of a process used for creating an electronic check in an ATM in accordance with a preferred embodiment of the present invention; and

FIG. 11 is a flowchart of a process used for creating an electronic check in accordance with a preferred embodiment of the present invention.

### DETAILED DESCRIPTION OF THE PREFERRED EMBODIMENT

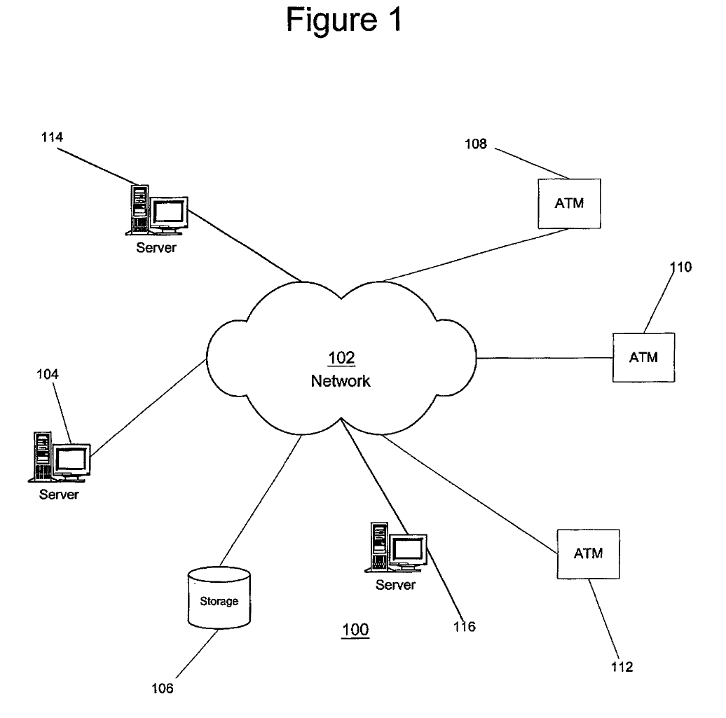

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, a server 104 is connected to network 102 along with storage unit 106. Server 104 is a computer located at a financial institution, such as a bank, a credit union, a mortgage company, or a brokerage firm.

Server 104 is used to provide various functions relating to daily financial transactions handled by the bank, such as deposits and withdrawals of funds. In addition, ATMs 108, 110, and 112 also are connected to network 102. ATMs 108, 110, and 112 are clients to server 104. Server 104 is in communication with ATMs 108, 110, and 112 to handle various transactions that users may initiate at these devices. For example, if a user withdraws cash from ATM 108, the debiting of the account is handled by server 104.

Server 114 and server 116 also are connected to network 102 and may represent computers located at other financial institutions. ATMs 108, 110, and 112 also may be clients to these servers depending on the particular user accessing ATMs 108, 110 and 112. Additionally, these servers may also represents computers located at other financial institutions, such as a regional clearinghouse, a national clearinghouse, or a Federal Reserve Bank. The present invention provides for scanning of checks at an ATM, such as ATM 108, when a user deposits a check with the financial institution. An image of both sides of the check is made when the check is deposited. Additionally, optical character recognition (OCR) is performed on the check to obtain information, such as the recipient of the check, and the amount of funds to be transferred from the account. Further, a magnetic ink reader reads magnetic ink data on the check to obtain information, such as the bank's identification number as well as the user's checking account number with the bank.

A markup language document is created. This document contains information obtained from the check. The markup language document forms an electronic check in these examples. Additionally, the image of the check also may be associated with the markup language document as part of the electronic check. This electronic check is then sent from ATM 108 to server 104 for processing. The image may take various forms, such as, for example, a Graphics Interchange Format (GIF) file or a Joint Photographic Experts Group (JPEG) file. GIF is a popular bitmapped graphics file format, supports 8-bit color (256 colors), and is widely used on the Web, because the files compress well. GIFs include a color table that includes the most representative 256 colors used. For example, a picture of the forest would include mostly greens. This method provides excellent realism in an 8-bit image. JPEG is an ISO/ITU standard for compressing still images. This standard has a high compression capability. Discrete cosine transforms are used and provide lossy compression with ratios up to 100:1 and higher. Some data is lost from the original image. The amount of compression depends on the image, but ratios of 10:1 to 20:1 may provide little noticeable loss. Compression is achieved by dividing the picture into tiny pixel blocks, which are halved over and over until the ratio is achieved.

Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

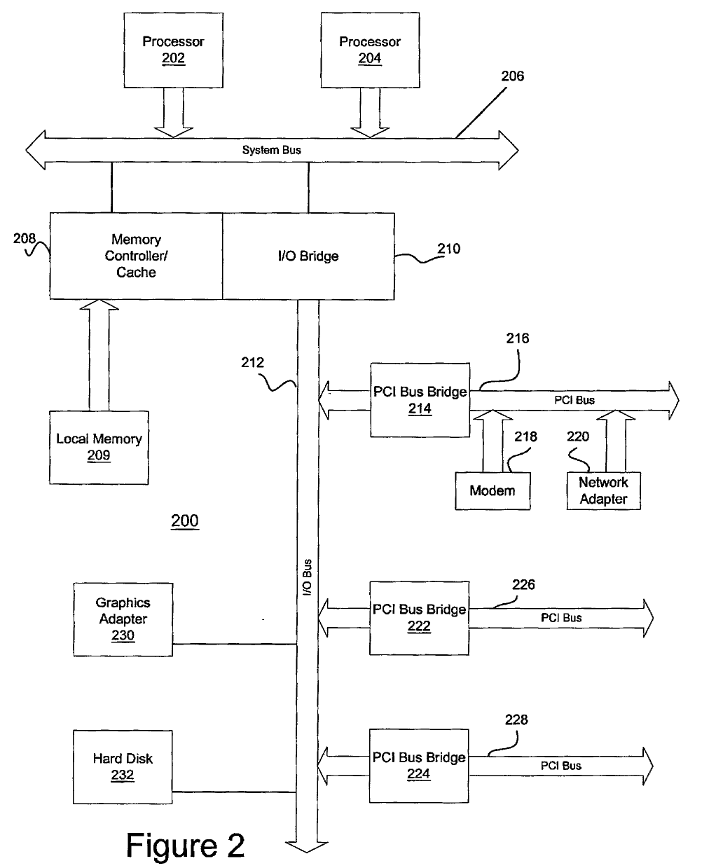

Referring to FIG. 2, a block diagram of a data processing system that may be implemented as a server, such as server 104, 114, or 116 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to ATMs 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

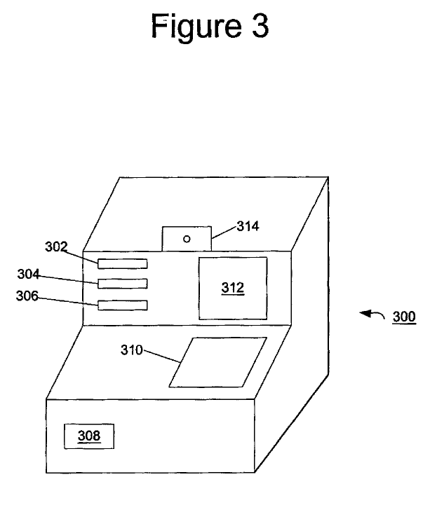

Turning next to FIG. 3, a diagram illustrating an automatic teller machine (ATM) is depicted in accordance with a preferred embodiment of the present invention. ATM 300 is an illustration of an ATM, such as ATM 108, 110 or 112 in FIG. 1.

In this example, an ATM card or a smart card may be received in slot 302. ATM 300 also includes an input slot 304 and an output slot 306. Input slot 304 is used to receive items, such as cash or a check for deposit. Cash dispenser slot 308 is used to dispense cash to a user. Keypad 310 provides an input device for a user to input information, such as an amount of money that is to be deposited or to make selections, such as receiving an account balance or an amount of cash to withdraw. Display 312 is used to present information to the user. Video camera 314 provides for recording transactions.

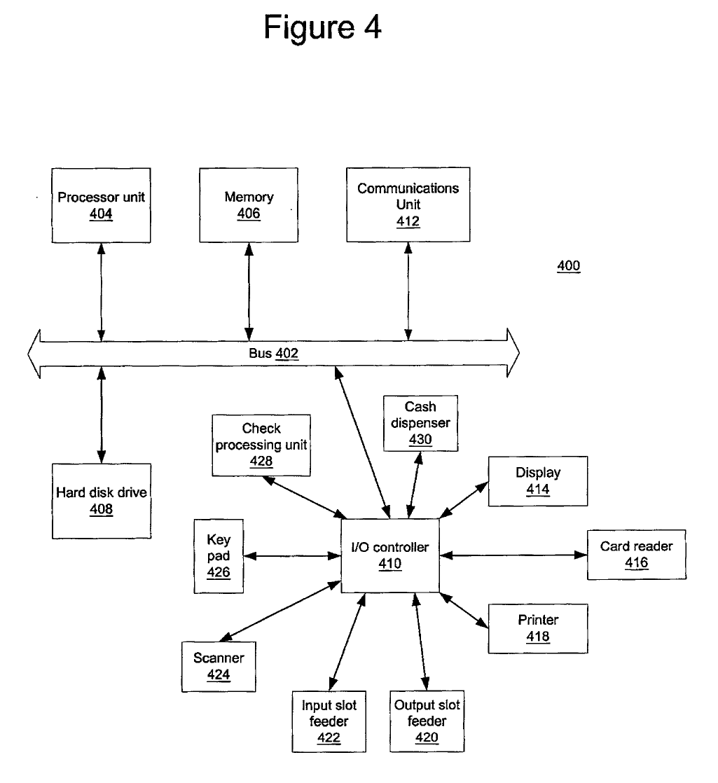

Turning next to FIG. 4, a block diagram illustrating an ATM is depicted in accordance with a preferred embodiment of the present invention. ATM 400 may be implemented as a ATM 108, 110, or 112 in FIG. 1.

In the depicted examples, bus 402 connects processor unit 404, memory 406, hard disk drive 408, I/O controller 410, and communications unit 412. Computer instructions may be located in memory 406 or in hard disk drive 408. These instructions are processed by processor unit 404 to provide ATM functions as well as the check scanning and electronic check creation processes of the present invention. Additionally, transaction information may also be stored on hard disk drive 408. Communications unit 412 provides for establishing a communications link with a server, such as server 104, 114 or 116 in FIG. 1 through a network, such as network 102 in FIG. 1.

I/O controller 410 provides a mechanism for input/output devices, such as, for example, display 414, card reader 416, printer 418, output slot feeder 420, input slot feeder 422, scanner 424, keypad 426, check processing unit 428, and cash dispenser 430. Display 414 provides a mechanism to present information to the ATM user. Card reader 416 is used to read an ATM card or a smart card inserted into the ATM. Printer 418 is used to print a receipt or other information in response to a user input. Keypad 426 is used to receive user input.

Output slot feeder 420 is used to feed receipts generated by printer 418 to an output slot, such as output slot 306 in FIG. 3. Input slot reader 422 is used to receive checks or cash placed into an input slot, such as input slot 304 in FIG. 3. Check processing unit 428 is used to move a check within the ATM. In particular, check processing unit 428 may move a check into a position for scanning by scanner 424 and then move the check into storage. If a check in not accepted, the check may be returned to output slot 420 for return to a user. Cash dispenser 430 is used to dispense cash when a user withdrawals funds from a user account.

The components depicted in FIGS. 3 and 4 are provided for purposes of illustration and are not meant to imply architectural limitations to the present invention.

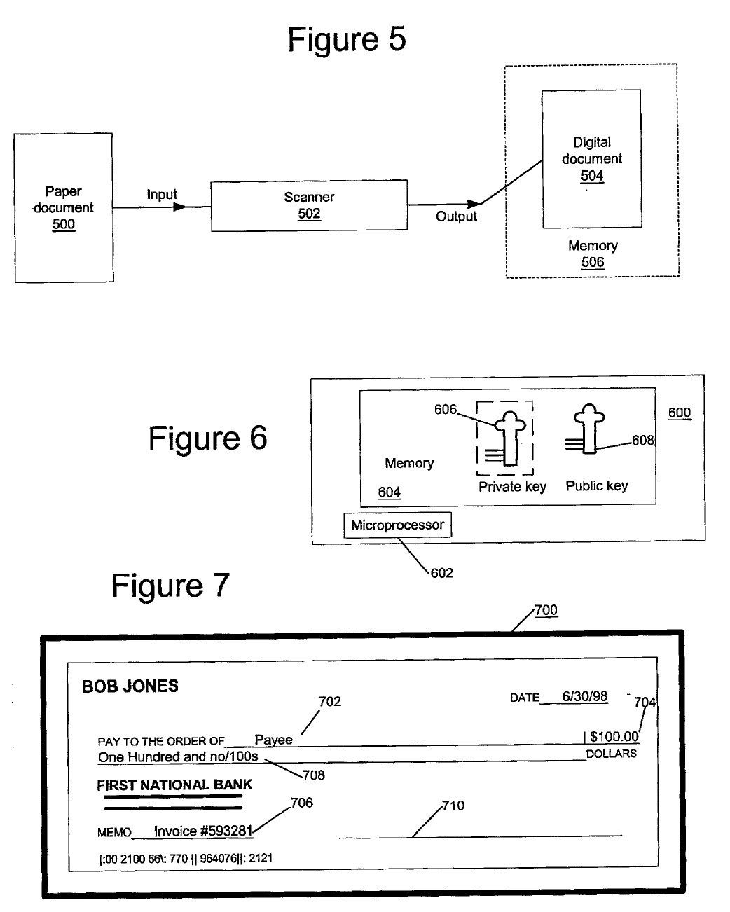

Turning next to FIG. 5, a diagram illustrating data flow in creating a check image is depicted in accordance with a preferred embodiment of the present invention. Paper document 500 is input or placed into an ATM, such as ATM 300 through input slot 304 in FIG. 3. In this example, paper document 500 is a check. Other types of documents that may be processed include, for example, a bill, a money order, a tax form, and a bank draft. Scanner 502 scans both sides of paper document 500. In this manner, endorsements as well as signature and amount information from the front of the check may be obtained. Digital document 504 is generated by scanner 502 and stored in memory 506 for further processing. Optical character recognition (OCR) processes may be initiated to process digital document 504 to generate information used to create a markup language representation of paper document 500. In these examples, this markup language representation form an electronic check.

With reference now to FIG. 6, a diagram of a smart card, which may be used to create an electronic check, is depicted in accordance with a preferred embodiment of the present invention. Smart card 600 is a credit card with microprocessor 602 and memory 604 and is used for identification or financial transactions. When inserted into a reader, such as through slot 302 in ATM 300 in FIG. 3, smart card 600 transfers data to and from ATM 300. In these examples, smart card 600 contains private key 606 and public key 608 within memory 604. These keys are used for digital signing of checks in these examples.

More precisely, the private key is used in the process of applying a digital signature to an electronic check or an electronic document. Applying a digital signature by using hashing operations in a private key is well known to those of ordinary skill in the art. However, for other activities the public key of an individual is also typically stored in a smart card and this is how smart card 600 has been depicted. Note that smart card 600 is depicted for the purposes of the preferred embodiment of the present invention. Other cards, such as credit cards may also be used. Popular usage does not normally refer to credit cards as smart cards. However, technically speaking even credit cards are a type of smart card and are governed by internationally accepted appropriate smart card standards. Hence, the preferred embodiment of the present invention is illustrated through a generic smart card in preference to a conventional credit card or an ATM card.

Smart card 600 is more secure than a magnetic stripe card and can be programmed to self-destruct if the wrong password is entered too many times. As a financial transaction card, smart card 600 can be loaded with digital money and used like a travelers check, except that variable amounts of money can be spent until the balance is zero.

Turning now to FIG. 7, a diagram of a check presented on a display for completion is depicted in accordance with a preferred embodiment of the present invention. Check 700 is an example of a check, which may be presented to a user on a display, such as display 312 in ATM 300 in FIG. 3. Check 700 is presented to the user after verification of the user's authority to generate a check.

In the depicted examples, the verification is made by an insertion of a smart card in an ATM, such as ATM 300 in FIG. 3 along with entry of a correct password or PIN. The user may enter information into payee field 702, amount field 704 and memo field 706. Entry of an amount in amount field 704 results in amount field 708 being automatically filled for the user. In this example, payee field 702 and amount field 704 are required fields that must be filled in for check 700 to be complete. Memo field 706 is an optional field, which may be left blank. In the depicted examples, a digital signature is used to complete the check and may be provided through the smart card. Depending on the implementation, the user may actually sign field 710 using a stylus if the display includes a touch screen to accept such data. Alternatively, both a digital signature and a signature created by the user with a stylus may be employed.

When the user affirms that the check is complete and should be sent, the check may then be routed to the payee or to some other party in the form of an electronic check. The electronic check is in the form of a markup language document as described above. More specifically, financial services markup language (FSML) is an example of a markup language, which may be used to generate electronic checks.

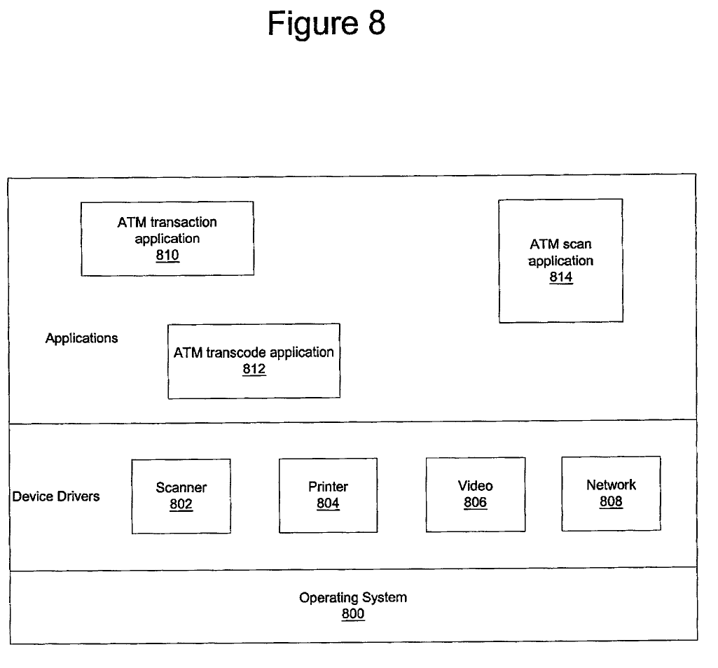

Turning next to FIG. 8, a diagram illustrating software components in an ATM is depicted in accordance with a preferred embodiment of the present invention. In this example, the software components in an ATM include operating system 800, scanner device driver 802, printer device driver 804, video device driver 806, network device driver 808, ATM transaction application 810, ATM transcode application 812, and ATM scan application 814.

The device drivers provide the components needed to operate devices within an ATM. These device drivers are used by ATM transaction application 810, ATM transcode application 812, and ATM scan application 814 to perform various input/output functions.

ATM transaction application 810 provides processes for various transactions by a user. Cash withdrawals, balance inquiries, fund transfers, and deposits are examples of transactions that may be handled through ATM transaction application 810. Additionally, ATM transaction application 810 handles the transmission and receipt of information to and from various financial institutions. When a check is deposited, ATM scan application 814 is initiated to create an image of the check. In the depicted examples, the image is of both sides of the check. Additionally, ATM scan application 814 also will include optical character recognition (OCR) processes to obtain data for use in creating an electronic check. This data is used by ATM transcode application 812 to generate a markup language representation of the check. In these examples, the markup language may be financial services markup language (FSML) and signed document markup language (SDML). FSML is used to implement electronic checks and other secure financial documents. FSML defines a method to structure documents into blocks of tagged content. Unlike HTML, which uses tags to inform processors about how to display content, FSML uses tags to inform processors about how to use the document content in financial applications. The FSML content blocks in an FSML document can be cryptographically sealed and signed in any combination needed by business applications. Document processors may also remove blocks without invalidating the signatures on the remaining blocks. They may combine signed documents and then sign blocks contained in the combined documents. Signatures are themselves structured as FSML blocks, as are the X.509 certificates needed by downstream processors to verify the signatures. Thus signatures and certificates become part of the FSML document, so they can be verified and countersigned by later signers.

SDML is designed to tag the individual text items making up a document, group the text items into document parts which can have business meaning and can be signed individually or together, allow document parts to be added and deleted without invalidating previous signatures, and allow signing, cosigning, endorsing, co-endorsing, and witnessing operations on documents and document parts. The signatures become part of the SDML document and can be verified by subsequent recipients as the document travels through the business process. SDML does not define encryption, since encryption is between each sender and receiver in the business process and can differ for each link depending on the transport used. SDML is the generic document structuring and signing part of the FSML.

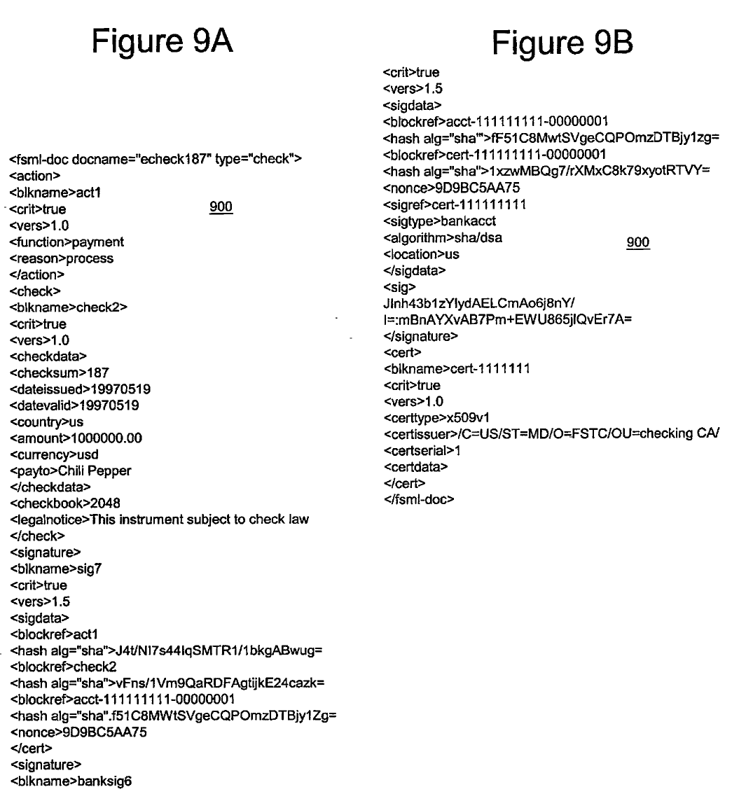

Referring now to FIGS. 9A-9B, a diagram of an electronic check is depicted in accordance with a preferred embodiment of the present invention. Electronic check 900 is in the form of a financial services markup language (FSML) document. This example illustrates some fields that may be found within an electronic check. In this example, electronic check 900 does not illustrate the actual certificate used in the document. Electronic check 900 is an example of an electronic check, which may be created by transcode application 812 in FIG. 8 in response to scanning a check or creating a check, such as check 700 in FIG. 7.

In the depicted examples, the markup language document forms an electronic check, such as an electronic representation of a physical check. Depending on the implementation, the electronic check also may include the image of the check.

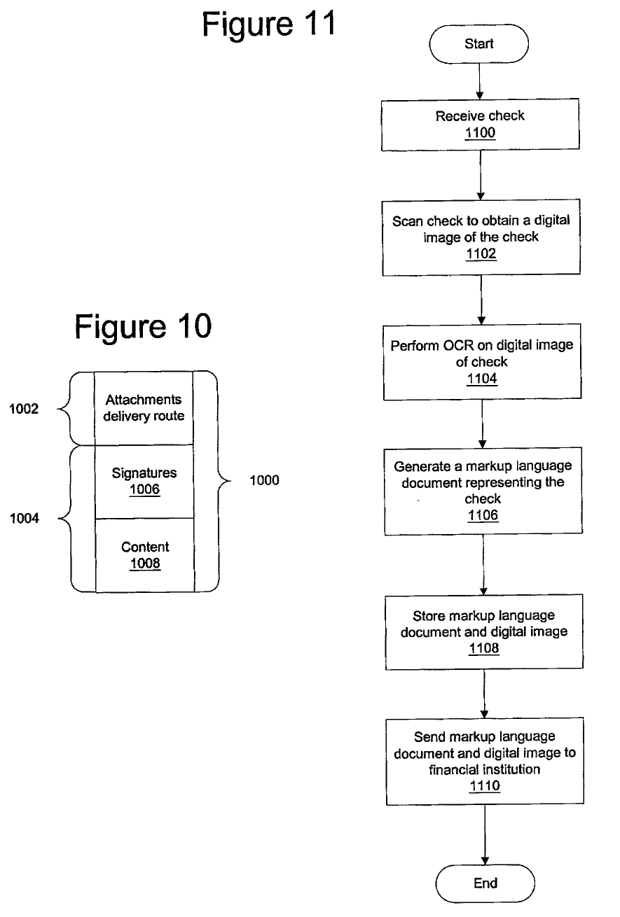

Turning next to FIG. 10 an illustration of a message sent from an ATM to a financial institution is depicted in accordance with a preferred embodiment of the present invention. Message 1000 is an example of a message that may be sent from an ATM to a financial institution. For example, an electronic check generated at an ATM, such as ATM 108 in server 104 in FIG. 1 for processing. The electronic check may be sent within message 1000.

Message 1000 includes header 1002 and body 1004. Header 1002 may include information, such as an identification of attachments and a delivery route for the message. Body 1004 may include signature 1006 as well as content 1008. Signature 1006 may be obtained from scanning of the check or via a digital signature from a smart card held by the user. Content 1008 may contain the digital image of the check and/or an electronic check, such as the electronic check illustrated in FIGS. 9A-9B. The electronic check may be a document created using FSML and/or SDML.

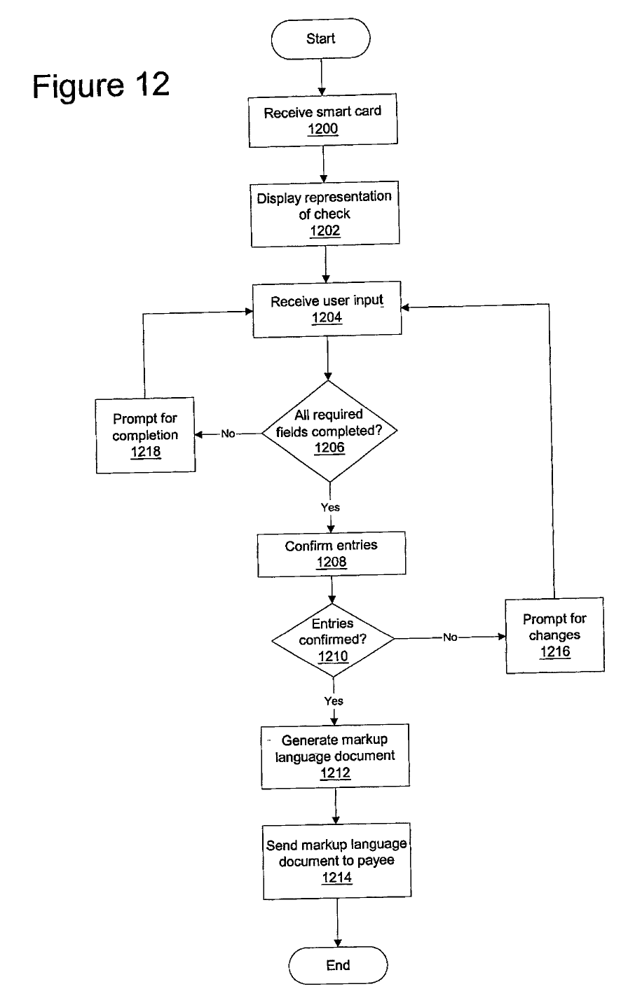

Turning next to FIG. 11, a flowchart of a process used for creating an electronic check in an ATM is depicted in accordance with a preferred embodiment of the present invention. The process illustrated in FIG. 11 may be implemented within ATM scan application 814 and ATM transcode application 812 in FIG. 8.

The process begins by receiving a check (step 1100). Next, the check is scanned to obtain a digital image of the check (step 1102). In these examples, both sides of the check are scanned. Additionally, this scanning step also may include reading magnetic ink data on the check, which may contain a bank identification number and a checking account number. Optical character recognition (OCR) is performed on the digital image of the check to generate data for use in creating an electronic check (step 1104).

Then, a markup language document is generated representing the check (step 1106). This markup language document forms an electronic check in this example. The markup language document and digital image is stored (step 1108). Thereafter, the markup language document and the digital image are sent to the financial institution (step 1110) with the process terminating thereafter. The markup language document and digital image are sent to the financial institution through a communications link, such as one provided by network 102 in FIG. 1.

In this manner, the check deposited by the ATM user can be processed without requiring further physical handling to transfer funds to the ATM user's account. Thus, the process used for transferring funds between accounts may be streamlined through the creation of electronic checks from physical checks at an ATM.

Turning next to FIG. 12, a flowchart of a process used for creating an electronic check is depicted in accordance with a preferred embodiment of the present invention. The process illustrated in FIG. 12 may be implemented in a set of computer instructions for use in applications, such as ATM transaction application 810 and ATM transcode application 812 in FIG. 8.

The process begins by receiving a smart card, such as smart card 600 in FIG. 6 from a user (step 1200). Next, a representation of a check, such as check 700 in FIG. 7 is displayed (step 1202). The user is the payor in this example. User input is then received (step 1204). This user input includes entry of information into fields, such as an amount for the check, a payee, and a memo. A determination is then made as to whether all required fields are completed (step 1206).

If all required fields are completed, the entries are confirmed (step 1208). This confirmation allows the user one last chance to make changes or cancel the check before the transaction is initiated. Next, a determination is then made as to whether the entries are confirmed (step 1210). If confirmed, a markup language document is generated (step 1212). This document forms the electronic check. The markup language document is then sent to a the payee, the payee's financial institution, or some third party authorized to receive checks for the payee (step 1214) with the process terminating thereafter.

With reference again to step 1210, if the entries are not confirmed, the user is prompted for changes (step 1216) and the process returns to step 1204 as described above. Turning back to step 1206, if all required fields are not completed, then the user is prompted for completion (step 1218) and the process returns to step 1204.

The processes illustrated in the figures may be carried out through devices interconnected to each other through various types of networks. For example, an ATM may communicate with a bank server through a secure network or using a virtual private network (VPN) over the Internet.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the smart card illustrated in the examples may be replaced by a regular credit card or ATM card with some loss in functionality. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing a check in an automatic teller machine, the method comprising:
receiving a check in the automatic teller machine;
scanning the check within the automatic teller machine to generate an image;
performing optical character recognition on the image to generate data; and
creating a markup language representation of the check using the data.

2. The method of claim 1, wherein the check includes a front side and a back side and wherein the scanning step comprises:
scanning both the front side and the back side of the check.

3. The method of claim 1, wherein the markup language representation is a financial services markup language representation.

4. The method of claim 1 further comprising:
sending the markup representation of the check to a financial institution.

5. The method of claim 4, wherein the financial institution is one of a bank, a credit union, a mortgage company, or a brokerage firm.

6. The method of claim 5 further comprising:
sending the image to the financial institution.

7. The method of claim 1, wherein the data further includes data created by reading magnetic ink data on the check.

8. A method in a data processing system for processing a check in an automatic teller machine, the method comprising:
responsive to receiving a request to generate a check at the automatic teller machine, verifying an originator of the check;
responsive to verifying the an originator, receiving user input defining the check to form check data; and
creating an electronic check using the check data.

9. The method of claim 8 further comprising:
presenting an image of a check including user input fields.

10. The method of claim 8, wherein the electronic check is a markup language document.

11. The method of claim 10, wherein the markup language document includes an electronic signature.

12. The method of claim 10, wherein the markup language document is a financial services markup language.

13. The method of claim 8, wherein the originator of the check is verified using at least one of a smart card and automatic teller machine card with a personal identification number.

14. The method of claim 8 further comprising:
transmitting the electronic check to a financial institution.

15. An automatic teller machine comprising:
a check processing unit, wherein the check processing unit receives and manipulates checks received by the automatic teller machine;
a cash money dispenser, wherein the cash money dispenser is operable to dispense currency in response to a selected signal;
a scanner unit, wherein the scanner unit is operable to scan checks;
a memory, wherein the memory includes a set of instructions; and
a processor unit, wherein the processor unit executes the set of instructions to initiate scanning of the check by the scanning unit to generate an image of the check, perform optical recognition on the image of the check for generate data, and create a markup language representation of the check from the data.

16. The automatic teller machine of claim 15, wherein the processor unit further executes the set of instructions to generate the selected signal in response to a particular user input.

17. An automatic teller machine comprising:
a check processing unit, wherein the check processing unit receives and manipulates checks received by the automatic teller machine;
a cash money dispenser, wherein the cash money dispenser is operable to dispense currency in response to a selected signal;
a scanner unit, wherein the scanner unit is operable to scan checks;
a memory, wherein the memory includes a set of instructions; and
a processor unit, wherein the processor unit executes the set of instructions to verifying an originator for a the check in response to receiving a request to generate a check at the automatic teller machine; receiving user input defining the check to form check data in response to verifying the an originator; and create an electronic check using the check data.

18. A data processing system for processing a check in an automatic teller machine, the data processing system comprising:
receiving means for receiving a check in the automatic teller machine;
scanning means for scanning the check within the automatic teller machine to generate an image;
performing means for performing optical character recognition on the image to generate data; and
creating means for creating a markup language representation of the check using the data.

19. The data processing system of claim 18, wherein the check includes a front side and a back side and wherein the scanning means comprises:
means for scanning both the front side and the back side of the check.

20. The data processing system of claim 18, wherein the markup language representation is a financial services markup language representation.

21. The data processing system of claim 18 further comprising:
sending means for sending the markup representation of the check to a financial institution.

22. The data processing system of claim 21, wherein the financial institution is one of a bank, a credit union, a mortgage company, or a brokerage firm.

23. The data processing system of claim 22, wherein the sending means is a first sending means and further comprising:
second sending means for sending the image to the financial institution.

24. The data processing system of claim 18, wherein the data further includes data created by reading magnetic ink data on the check.

25. A data processing system for processing a check in an automatic teller machine, the data processing system comprising:
verifying means, responsive to receiving a request to generate a check at the automatic teller machine, for verifying an originator of the check;
receiving means, responsive to verifying the an originator, for receiving user input defining the check to form check data; and
creating means for creating an electronic check using the check data.

26. The data processing system of claim 25 further comprising:
presenting means for presenting an image of a check including user input fields.

27. The data processing system of claim 25, wherein the electronic check is a markup language document.

28. The data processing system of claim 27, wherein the markup language document includes an electronic signature.

29. The data processing system of claim 27, wherein the markup language document is a financial services markup language.

30. The data processing system of claim 25, wherein the originator of the check is verified using at least one of a smart card and automatic teller machine card with a personal identification number.

31. The data processing system of claim 25 further comprising:
transmitting means for transmitting the electronic check to a financial institution.

32. A computer program product in a computer readable medium for processing a check in an automatic teller machine, the computer program product comprising:
first instructions for receiving a check in the automatic teller machine;
second instructions for scanning the check within the automatic teller machine to generate an image;
third instructions for performing optical character recognition on the image to generate data; and
fourth instructions for creating a markup language representation of the check using the data.

33. A computer program product in a computer readable medium for processing a check in an automatic teller machine, the computer program product comprising:
first instructions, responsive to receiving a request to generate a check at the automatic teller machine, for verifying an originator of the check;
second instructions, responsive to verifying the an originator, for receiving user input defining the check to form check data; and
third instructions for creating an electronic check using the check data.
